(19) United States
(12) Patent Application Publication
(10) Pub. No.: US 2026/0141047 A1
(43) Pub. Date: May 21, 2026

(54) DYNAMIC AUTHENTICATION MODE CHANGE BASED ON EMERGENCY CONDITION DETECTION

(71) Applicant: MOTOROLA MOBILITY LLC, WILMINGTON, DE (US)

(72) Inventors: AMIT KUMAR AGRAWAL, BANGALORE (IN); PANDURANGA REDDY PAILLA, NALGONDA (IN); Shuaib Puzhakkal Kavalathara, TIRUR (IN)

(21) Appl. No.: 18/955,063

(22) Filed: Nov. 21, 2024

(51) Int. Cl. G06F 21/40; G06F 21/32

(52) U.S. Cl. CPC G06F 21/40; G06F 21/32

(57) ABSTRACT

A method includes activating, on an electronic device, a device secure lock mode comprising a screen lock that requires entry of at least one authentication input, including a biometric authentication input, to unlock the electronic device. While the screen lock is activated, an emergency condition is detected based on trigger data received by the electronic device. In response to detecting the emergency condition, biometric authentication is automatically deactivated, enabling unlocking of the electronic device without requiring the biometric authentication.

### BACKGROUND

### 1. Technical Field

The present disclosure generally relates to electronic devices, and more specifically to emergency detection actions of electronic devices.

### 2. Description of the Related Art

Smartphones have become central to storing a wide array of important personal and practical information. They often hold contact details, such as phone numbers, emails, and social media profiles, related to family, friends, and professional contacts. With their integration into daily life, smartphones increasingly contain sensitive data like names, addresses, birthdates, and digital copies of identification documents. This reliance has contributed to the shift from physical to digital identification, including driver's licenses and insurance cards, now frequently stored on mobile devices. This evolution in digital identity management is propelled by factors such as convenience, improved security, and advances in technology. Governments, insurance providers, and individuals are adopting digital documentation at a rapid pace, signaling an ongoing trend toward digital identities as technology continues to develop. This shift not only offers practicality but also represents a milestone in how individuals manage and protect their personal information in the digital era.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of an electronic device with specific components that enable the device to dynamically change an authentication mode based on emergency condition detection, according to one or more embodiments;

FIG. 2 illustrates an example scenario in which an emergency condition is detected in a non-trusted location, according to one or more embodiments;

FIG. 3 is an example of a user interface prompting biometric authentication in a non-trusted location when no emergency condition is detected, according to one or more embodiments;

FIG. 4 is an example of a user interface showing disabling of biometric authentication in a non-trusted location when an emergency condition is detected, according to one or more embodiments;

FIG. 5 is an example of a user interface showing an emergency detection user interface, according to one or more embodiments;

FIG. 6 depicts a flowchart of a computer-implemented method for dynamically changing an authentication mode based on detection of an emergency condition detection, according to one or more embodiments; and

FIG. 7 depicts a flowchart of a computer-implemented method for selecting between a two-factor authentication (2FA) that includes biometric authentication and a non-biometric one-factor authentication (1FA) based on detection of an emergency condition, according to one or more embodiments.

### DETAILED DESCRIPTION

According to aspects of the present disclosure, an electronic device, a method, and a computer program product provide techniques for dynamically changing a device login authentication mode based on detection of an emergency condition, according to one or more embodiments. In one or more embodiments, the electronic device determines whether its current geographic location is a trusted or a non-trusted location. Under normal circumstances, when the electronic device is in a non-trusted location, a two-factor authentication (2FA) that includes a biometric authentication of the device user may be required to unlock the electronic device. However, in response to detecting an emergency situation, disclosed embodiments can disable any biometric authentication requirements, enabling the electronic device to be unlocked, and/or providing access to secure content on the device, using only non-biometric authentication techniques.

Emergency situations can arise unexpectedly, and can pose immediate risks to a device user's safety and/or well-being. These emergencies may involve accidents or medical crises, leaving the user unconscious, critically injured, or even deceased. In such cases, when the person is admitted to a medical facility, family members may be asked to provide insurance information, identification, legal documents, and other essential records, such as a power-of-attorney or will. Many of these documents may be stored on or accessible through the user's smartphone, which is often, by default, protected by multiple layers of security, including biometric authentication, requiring the user's biometrics to unlock the device and/or access secure folders stored within the device. In the case of an emergency, some of this protected information can be essential for resolving the emergency situation. In situations where an associated user of an electronic device has sustained injuries that prevent the user from performing/providing biometric authentication, such as facial injuries, cognitive injuries, and/or injuries to hands, biometrically unlocking an electronic device may not be possible. In such emergency situations, being able to access important information on a user device, such as medical records, and insurance information, can make a difference in the outcomes for the person(s) that are involved in the emergency situation.

The disclosed embodiments address the aforementioned issues by automatically disabling biometric authentication in response to detecting an emergency condition, enabling access to the user's device to obtain information from the user's device using only non-biometric authentication techniques. The information can include contact information for one or more contacts, medical information, insurance information, and/or other important instructions and/or information useful for the purposes of providing aid to a user who is involved in an emergency. With disclosed embodiments, if a user is severely injured and/or unconscious due to an emergency condition, a relative or loved one of the user that knows the non-biometric credentials for the electronic device can get the electronic device unlocked, to access the secure information such as medical records, power-of-attorney documents, wills, and the like. In embodiments, the non-biometric credentials can include a passphrase, passcode, personal identification number (PIN), answers to secret questions, and/or other non-biometric credential information. In one or more embodiments, the non-biometric credential information is automatically transmitted to the device of the relative, loved one, or other person designated (e.g., by the user or based on proximity to the user's electronic device, etc.) to receive the non-biometric credentials to access the electronic device.

According to one aspect, data received from one or more sensors are continuously or periodically monitored for trigger data indicative of an emergency condition. The sensors can include accelerometers, motion sensors, biometric sensors, among others. In response to detecting the trigger data that indicates an emergency condition, biometric authentication can be disabled on an electronic device. The biometric authentication can include face recognition, fingerprint identification, voiceprint identification, and the like. Another person, such as a friend or family member of the user, who knows or receives (e.g., in response to detection by the user device of the emergency condition) the non-biometric credentials for the user's electronic device can then unlock the electronic device while at the non-trusted location, in order to retrieve important emergency information, such as medical information, insurance information, and the like. The emergency information can include a contact list, health insurance information, medical information, and/or other information that may be needed or useful to have as a result of an emergency such as a serious injury of the user.

In some embodiments, the biometric authentication methods can include face recognition and/or fingerprint identification. Moreover, a user may establish one or more trusted locations, such as work, home, school, a friend's home, etc. To protect user data, the electronic device can be configured such that, when in a non-trusted location, which can be any location that is outside of the user-specified trusted location(s), a biometric authentication method is required for unlocking the electronic device. In this way, if an electronic device is stolen or misappropriated, the device cannot be unlocked, even if the PIN, passphrase, and/or passcode is known by the person, thereby safeguarding access to sensitive user information. While the requirement for biometric authentication is good for preventing data from being accessed from a stolen device, in the case where a user is injured in a way where face recognition, fingerprint identification, voice identification, and/or other biometric authentication is not possible, the requirement for biometric authentication to unlock an electronic device at a non-trusted location can be a disadvantage. Disclosed embodiments provide functionality in which the device detects an emergency condition and disables the biometric authentication on the electronic device in response to detecting the emergency condition.

Disclosed embodiments enable access to a user's electronic device via non-biometric authentication techniques in response to detecting an emergency condition. Any biometric authentication techniques that were required for accessing the device are disabled. As an example, if a user is involved in a serious accident, another person (e.g., a spouse) that knows the non-biometric credentials (e.g., a passcode) for the user's electronic device, can unlock the user's electronic device to retrieve, from the user's electronic device, important information, such as insurance, and/or other medical information, such as a medication list, list of allergies, and/or medical conditions. In this way, relevant information is accessible despite the user not being able or available to provide biometric authentication, which can be of value in providing medical treatment for the user.

One or more embodiments can provide an electronic device that includes: a display; at least one biometric sensor enabling the electronic device to be unlocked via a biometric authentication process; a memory having stored thereon an emergency biometric authentication deactivation (EBAD) module; and at least one processor coupled to the display, the at least one biometric sensor, and the memory and which processes program code of the EBAD module. The at least one processor is configured to cause the electronic device to: activate a device secure lock mode comprising a screen lock that requires entry of at least one authentication input, including a biometric authentication input, to unlock the electronic device; while the screen lock is activated, detect an emergency condition based on trigger data received by the at least one processor; and in response to the emergency condition, deactivate biometric authentication and enable access to unlock the electronic device without requiring the biometric authentication.

One or more embodiments can provide a method that includes: activating, on an electronic device, a device secure lock mode comprising a screen lock that requires entry of at least one authentication input, including a biometric authentication input, to unlock the electronic device; detecting, while the screen lock is activated, an emergency condition based on trigger data received by the electronic device; and in response to the emergency condition, deactivating biometric authentication and enabling access to unlock the electronic device without requiring the biometric authentication.

Further embodiments can provide a computer program product including: a non-transitory computer readable medium; and program code on the computer readable medium that when processed by a processor of an electronic device configures the processor to perform functions of the above-described method.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, and configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, “some embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

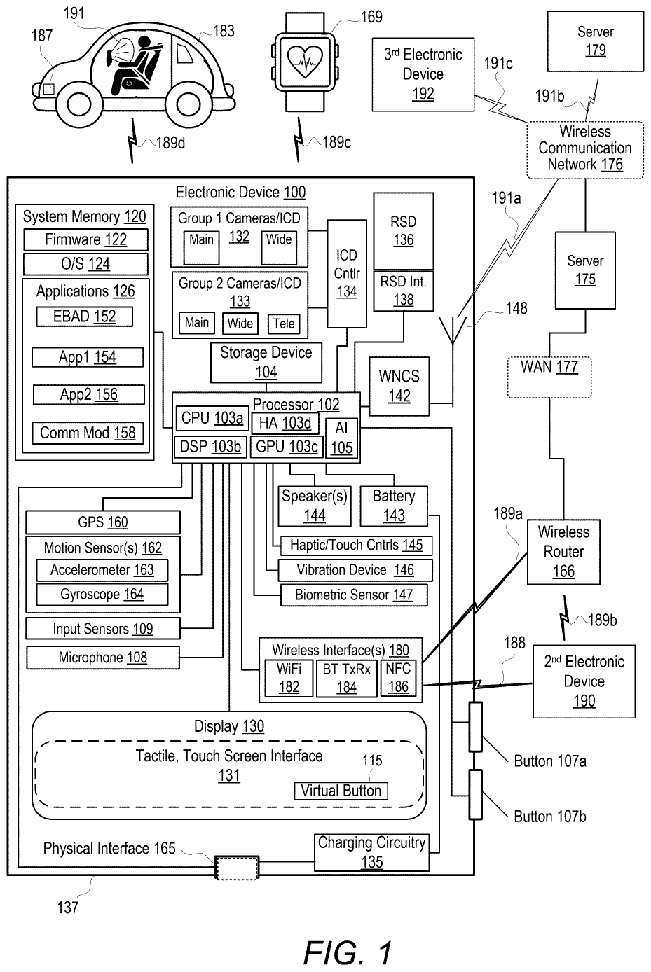

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, within which various aspects of the disclosure can be implemented, according to one or more embodiments. Examples of electronic device 100 include, but are not limited to, mobile devices, a notebook computer, a teleconference device, a mobile phone, a smart phone, a digital camera with enhanced processing capabilities, a smart watch, a tablet computer, and other types of electronic device.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124. Processor 102 can be and is interchangeably referred to as controller 102.

Processor 102 can, in some embodiments, include image signal processors (ISPs) (not shown) and dedicated artificial intelligence (AI) engines 105. In one or more embodiments, processor 102 can execute AI modules to provide AI functionality of AI engines 105. AI modules may include an artificial neural network, a decision tree, a support vector machine, Hidden Markov model, linear regression, logistic regression, Bayesian networks, and so forth. The AI modules can be individually trained to perform specific tasks and can be arranged in different sets of AI modules to generate different types of output. Processor 102 is communicatively coupled to storage device 104, system memory 120, input devices (introduced below), output devices, including integrated display 130, and image capture device (ICD) controller 134.

For simplicity in describing the features of the electronic device 100, the functionality provided by one or more of CPU 103a, DSP 103b, GPU 103c, and ICD controller 134 are collectively described as being performed by processor 102. Collectively, components integrated within processor 102 support computing, classifying, processing, transmitting and receiving of data and information, and presenting of graphical and photographic images within a display.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, emergency biometric authentication deactivation (EBAD) module 152, other applications, indicated as App 1 154 and App 2 156, and communication module 158. Each module and/or application provides program instructions/code that are processed by processor 102 to configure/cause processor 102 and/or other components of electronic device 100 to perform specific operations, as described herein. Descriptive names assigned to these modules add no functionality and are provided solely to identify the underlying features performed by processing the different modules. For example, emergency biometric authentication deactivation (EBAD) module 152 can include program instructions for implementing features of the disclosed embodiments. The EBAD module 152 can include instructions that cause or configure processor 102 to identify an emergency condition (or determine that an emergency condition exists based on received/sensed data), and in response, disable biometric authentication for electronic device 100. Other features are described in further detail throughout this disclosure.

ICD controller 134 can perform image acquisition functions in response to commands received from processor 102 in order to control group 1 ICDs 132 and group 2 ICDs 133 to capture video or still images of a local scene within a FOV of the operating/active ICD. In one or more embodiments, group 1 ICDs can be front-facing, and group 2 ICDs can be rear-facing, or vice versa. The term image capturing device (ICD) can be utilized interchangeably to be synonymous with and/or refer to any one of the cameras 132, 133. Both sets of cameras 132, 133 include image sensors that can capture images that are within the field of view (FOV) of each respective camera 132, 133. In one or more embodiments, ICDs 132, 133 can be utilized to enable biometric authentication using facial image or iris scan recognition.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device encoded with program code and corresponding data, and RSD 136 can be interchangeably referred to as a non-transitory computer program product. RSD 136 may have a version of one or more applications, such as a copy of EBAD module 152, stored thereon. Processor 102 can access RSD 136 to provision electronic device 100 with program code that, when executed/processed by processor 102, the program code causes or configures processor 102 and/or generally electronic device 100, to provide the various functions described herein.

Electronic device 100 includes an integrated display 130 which incorporates a tactile, touch screen interface 131 that can receive user tactile/touch input. As a touch screen device, integrated display 130 allows a user to provide input to or to control electronic device 100 by touching features within the user interface presented on integrated display 130. Tactile, touch screen interface 131 can be utilized as an input device. The touch screen interface 131 can include one or more virtual buttons, indicated generally as 115. In one or more embodiments, when a user applies a finger or stylus on the touch screen interface 131 in the region demarked by the virtual button 115, the touch of the region causes the processor 102 to execute code to implement a function associated with the virtual button. In some implementations, integrated display 130 is integrated into a front surface of electronic device 100 along with front ICDs, while the higher quality ICDs are located on a rear surface. Other embodiments provide multiple integrated displays within electronic device 100 and references to integrated display 130 are assumed to refer to any one and/or all of these multiple integrated displays.

Electronic device 100 can further include one or more input buttons, indicated as 107a and 107b, microphone 108, input sensors 109 (e.g., sensors enabling gesture detection by a user), and one or more output devices, such as speakers 144. While two buttons are shown in FIG. 1, other embodiments may have more or fewer input buttons. Input buttons 107a and 107b may provide controls for volume, power, and ICDs 132, 133. Microphone 108 can also be referred to as an audio input device. In some embodiments, microphone 108 may be used for identifying a user via voiceprint, voice recognition, and/or other suitable techniques.

Electronic device 100 further includes haptic touch controls 145, vibration device 146, fingerprint/biometric sensor 147, global positioning system (GPS) module 160, and motion sensor(s) 162. Vibration device 146 can cause electronic device 100 to vibrate or shake when activated. Vibration device 146 can be activated during an incoming call or message in order to provide an alert or notification to a user of electronic device 100. In one or more embodiments, integrated display 130, speakers 144, and vibration device 146 can generally and collectively be referred to as output devices.

Biometric sensor 147 can be used to read/receive biometric data, such as fingerprints, to identify or authenticate a user. In one or more embodiments, biometric (fingerprint) sensor 147 can be positioned underneath touch screen interface 131 of display 130. In some embodiments, the biometric sensor 147 can supplement an ICD (camera), which provides facial recognition for user detection/identification.

GPS module 160 can provide time data and location data about the physical location of electronic device 100 using geospatial input received from GPS satellites. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y and Z). Gyroscope 164 measures rotation or angular rotational velocity of electronic device 100. Electronic device 100 further includes a housing 137 (generally represented by the thick exterior rectangle) that contains/protects the components that are internal to electronic device 100.

Electronic device 100 also includes a physical interface 165. Physical interface 165 of electronic device 100 can serve as a data port and can be used as a power supply port that is coupled to charging circuitry 135 and device battery 143 to enable recharging of device battery 143 and/or powering of device.

Electronic device 100 further includes wireless network communication subsystem (WNCS) 142, which can represent one or more front end devices (not shown) that are each coupled to one or more antennas 148. In one or more embodiments, WNCS 142 can include a communication module with one or more baseband processors or digital signal processors, one or more modems, and a radio frequency (RF) front end having one or more transmitters and one or more receivers. Example communication module 158 within system memory 120 enables electronic device 100 to communicate with wireless communication network 176 and with other devices, such as server 175 and other connected devices, such as second electronic device 190 and/or third electronic device 192 via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WNCS 142 and antennas 148 allow electronic device 100 to communicate wirelessly with wireless communication network 176 via transmissions of communication signals 191a to and from network communication devices, such as base stations or cellular nodes, of wireless communication network 176. Wireless communication network 176 further allows electronic device 100 to wirelessly communicate with server 175, and other communication devices, such as third electronic device 192, which can be similarly connected to wireless communication network 176 via respective communication signals 191b and 191c. In one or more embodiments, second electronic device 190 and/or third electronic device 192, can be a communication device, such as a smartphone.

In one or more embodiments, electronic device 100 can communicate wirelessly with external wireless devices, such as a WiFi router 166 or second electronic device 190, via one or more of short-range wireless interface(s) 180. In one or more embodiments, WiFi router 166 may be connected to a WAN 177 and/or server 175. Server 175 may also be connected to wireless communication network 176, which may enable connection to other servers, such as server 179 via communication signal 189c. Electronic device 100 can wirelessly communicate with second electronic device 190 via communication signal 188 (communicating between wireless interface(s) 180 and second electronic device 190). Communication signal 189a and communication signal 189b provide a communication path from electronic device 100 to second electronic device 190. In one or more embodiments, signals 188 and/or signals 189a may be transmitted by short range communication device(s) within wireless interface(s) 180. In one or more embodiments, a wearable computing device 169, such as a smartwatch, fitness tracker, or the like, may be paired with electronic device 100, and provide biometric data such as heart rate, breathing rate, and the like, to the electronic device 100. Communication signal 189c may be used to enable communication between electronic device 100 and wearable computing device 169. Wireless interface(s) 180 can include short-range wireless communication adapters/transceivers, such as wireless fidelity (Wi-Fi) transceiver 182 for Wi-Fi connectivity, Bluetooth transceiver 184, and near field communication (NFC) transceiver 186. In one or more embodiments, electronic device 100 can receive Internet or Wi-Fi based calls, text messages, multimedia messages, and other notifications via wireless interface(s) 180. In one or more embodiments, WNCS 142 with antenna(s) 148 and wireless interface(s) 180 collectively provide/represent the wireless communications subsystem of electronic device 100.

In one or more embodiments, electronic device 100 may communicate with an in-vehicle computer 187 of a vehicle 183. In one or more embodiments, the communication signal 189d may include a Bluetooth signal, or other near field communication signal to enable information regarding the vehicle 183 to be communicated from the in-vehicle computer 187 to the electronic device 100. The information can include event information, such as indicating deployment of an airbag 191, which can be indicative of a collision, and thus, a potential emergency condition. Electronic device 100 of FIG. 1 is only a specific example of a device that can be used to implement the embodiments of the present disclosure.

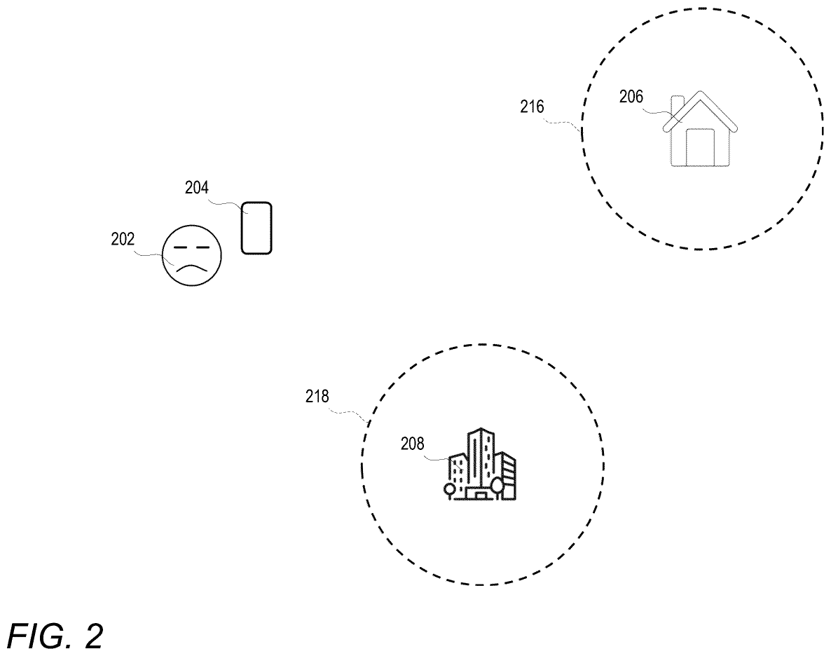

FIG. 2 illustrates an example scenario in which an emergency condition is detected in a non-trusted location, according to one or more embodiments. A first trusted area 216 is a perimeter around a home of a user, indicated as 206. A second trusted area 218 is a perimeter around a workplace of a user, indicated as 208. In one or more embodiments, the first trusted area 216 and second trusted area 218 may be established via GPS-based geofencing. The GPS-based geofencing can include using GPS coordinates to set a virtual perimeter around a given longitude latitude coordinate pair. A geofencing application can define a radius around a central point of geospatial data (such as longitude and latitude coordinates corresponding to an address of a home, office, or other location), and the electronic device can check its GPS location periodically to determine if operating within a trusted location. When geospatial data obtained from the GPS indicates that an electronic device is within the radius of a trusted location, the electronic device can enable trusted-location settings, such as reducing lock-screen security. Similarly, when the electronic device is outside of the established radius of a trusted location, the electronic device can enable non-trusted-location settings, such as requiring biometric authentication to access the device. Other embodiments may utilize cell tower triangulation instead of, or in addition to, GPS-based geofencing. With cell tower triangulation, signals from nearby cell towers are used to estimate the location of an electronic device. By using these techniques, an electronic device such as a smartphone can intelligently assess if it is within a defined “trusted location” and adjust security measures. For example, the electronic device might enable a quick-unlock feature at home while enforcing biometric authentication in public or untrusted areas. In an alternate embodiment, the electronic device can determine its location using WiFi triangulation with known location of a WiFi signal access point.

Referring again to FIG. 2, user 202 has an associated electronic device 204. As can be seen in FIG. 2, the electronic device 204 is outside of the first trusted area 216 and is also outside of the second trusted area 218. Accordingly, as electronic device 204 is not within any trusted area, it is therefore not in a trusted location (i.e., the electronic device 204 is in a non-trusted location). In a situation where user 202 is injured or rendered unconscious, the user may not be able to perform biometric authentication. As an example, if the user's fingers are injured in a fire, fingerprint biometric authentication to unlock an electronic device may not be possible. Note that while FIG. 2 illustrates an example where biometric authentication is only required in non-trusted locations, in some embodiments, the biometric authentication may be active regardless of location. In cases where biometric authentication is always active, upon detecting an emergency condition, the electronic device may substitute a non-biometric authentication method for the biometric authentication method. As an example, the electronic device may prompt a user for a passcode and/or security question and response instead of a biometric authentication technique such as fingerprint identification and/or facial recognition.

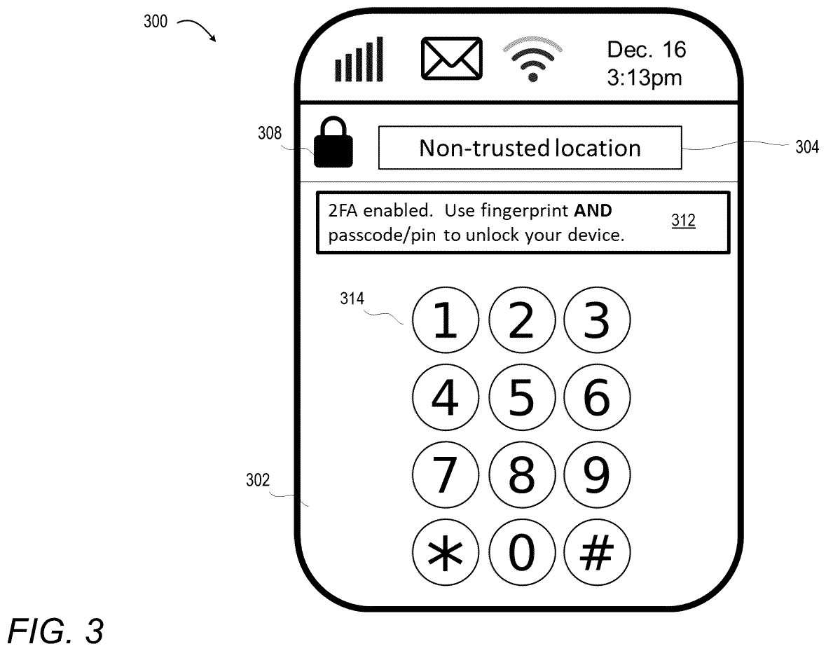

FIG. 3 is an example of a user interface (UI) prompting biometric authentication, while the device is in a non-trusted location, according to one or more embodiments. Device 300 may be similar to electronic device 100 depicted in FIG. 1. Device 300 includes display 302. The biometric authentication can be part of a multi-factor authentication (MFA) process. The MFA can include two-factor authentication (2FA). The two factors of authentication can include a passcode (non-biometric information), and a fingerprint identification (biometric information). Display 302 is rendering a non-trusted location indication 304, along with a locked device indication 308. Accordingly, when a user wishes to unlock the electronic device 300 in the non-trusted location, as stated by content within the instructional field 312, the user is required to use a fingerprint and a passcode (or PIN) entered on keypad 314 in order to unlock electronic device 300. As an example, for the device 204 shown in FIG. 2, when no emergency condition is detected, the electronic device 204 may display a user interface similar to that shown in FIG. 3.

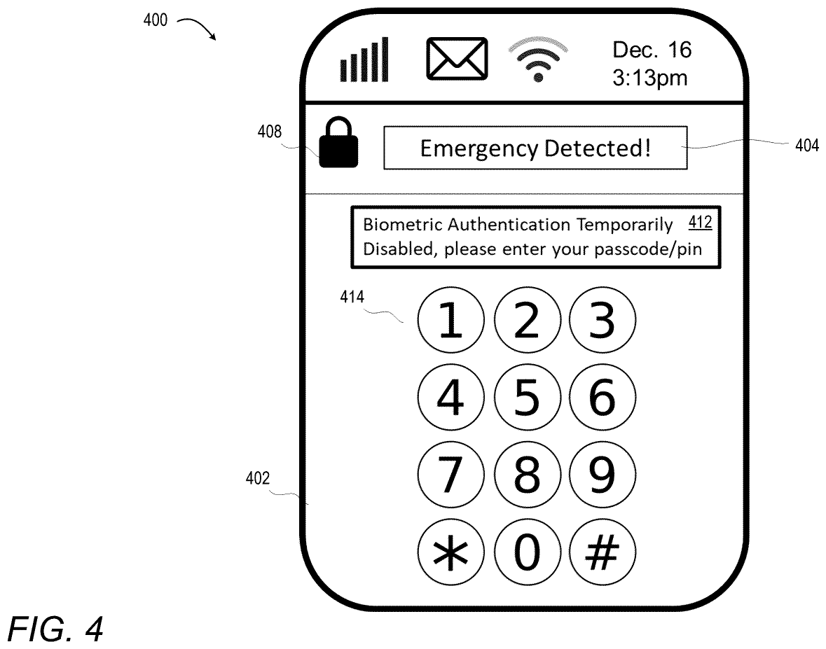

FIG. 4 is an example of a user interface showing disabling of biometric authentication in a non-trusted location when an emergency condition is detected, according to one or more embodiments. Device 400 may be similar to electronic device 100 depicted in FIG. 1. Device 400 includes display 402. Display 402 is rendering an emergency condition indication 404, along with a locked device indication 408. Accordingly, because device 100 has detected and presented emergency condition indication 404, biometric authentication is automatically disabled on electronic device 400. As per the instructional field 412, the user is only required to use a passcode (or PIN) (i.e., non-biometric authentication) entered on keypad 414 in order to unlock electronic device 400. In one or more embodiments, the at least one authentication input comprises a non-biometric authentication input, and the method further comprises, concurrently with deactivating the biometric authentication, presenting and rendering a prompt for non-biometric authentication. As an example, for the device 204 shown in FIG. 2, when an emergency condition is detected, the electronic device 204 may display a user interface similar to that shown in FIG. 4.

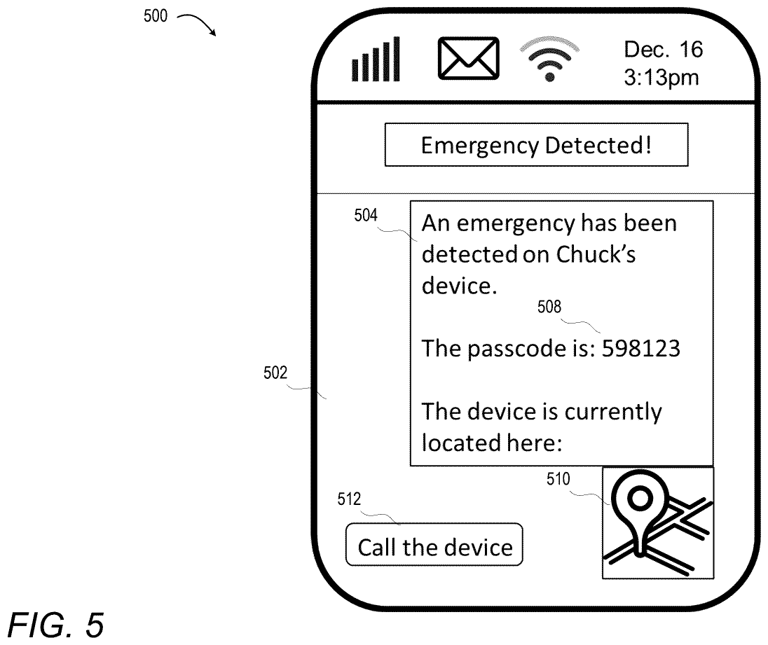

FIG. 5 is an example of a user interface showing an emergency detection user interface, according to one or more embodiments. Device 500 may be similar to electronic device 100 depicted in FIG. 1. Device 500 includes display 502. Rendered and presented on display 502 is an emergency detection user interface. In one or more embodiments, an emergency detection user interface such as shown in FIG. 5 can be rendered and presented on a second electronic device. As an example, the second electronic device can be associated with a family member or friend of the user. In one or more embodiments, in response to detecting an emergency condition, the electronic device associated with the user can send a notification to a second electronic device. The notification can include a text message and/or a message sent through a messaging app, a message sent via a special-purpose app, and/or other suitable messaging techniques.

The user interface includes an emergency indication field 504. The emergency indication field 504 can indicate that an emergency condition has been detected via the user's associated electronic device. The information in emergency indication field 504 can include a name of the person that is associated with the electronic device that detected an emergency condition. The information in emergency indication field 504 can further include a passcode 508 for unlocking the user's electronic device. In one or more embodiments, the information in emergency indication field 504 may include location information 510, which can indicate a current location of the device that detected the emergency condition. In one or more embodiments, the current location may be determined by an onboard GPS and/or cell tower and/or WiFi triangulation techniques. The user interface may further include a call button 512 which, when invoked, causes electronic device 500 to place a voice call to the user's electronic device. In this way, disclosed embodiments provide functionality such that a friend or family member can be notified of an emergency condition, and also get notified about the location of the device, and/or other relevant information. In one or more embodiments, the user establishes, ahead of time, one or more second devices to be notified in the event of an emergency condition being detected. Accordingly, disclosed embodiments enable sharing non-biometric access credentials for a user's electronic device with people the user trusts, in response to detecting an emergency condition via the user's electronic device.

There are various types of trigger data that can signify an emergency condition. In one or more embodiments, the trigger data can be obtained from a sensor within the electronic device of a user (e.g., device 100 of FIG. 1), such as an accelerometer, motion sensor, microphone, and/or biometric sensor. One or more embodiments can include detecting the emergency condition by receiving biometric data from a biometric sensor external to the electronic device, where the data is pre-established as trigger data corresponding to one emergency condition. The biometric sensors can provide signals indicative of heart rate, breathing rate, and/or other biometric information. As an example, trigger data received from a biometric sensor that indicates no heart rate can be used to determine a cardiac arrest emergency condition. Thus, in embodiments, the biometric trigger data that is received by an electronic device is correlated to an emergency condition. In one or more embodiments, the trigger data can be obtained from an external device, such as a wearable electronic device (e.g., 169 of FIG. 1). One or more embodiments can include detecting an emergency condition by receiving biometric trigger data from an external device that operates as a biometric sensor, where the biometric trigger data is correlated to an emergency condition.

In one or more embodiments, the trigger data can include trigger data received from an in-vehicle computer. As an example, the trigger data can include an accident indication that can be based on a sudden deceleration event, an airbag deployment event, hard braking, rapid steering, and/or other relevant events. In one or more embodiments, an airbag deployment event serves as trigger data corresponding to an emergency condition. In one or more embodiments, detecting an emergency condition comprises receiving trigger data from an in-vehicle computer, wherein the trigger data is correlated to an emergency condition. In one or more embodiments, detecting the emergency condition comprises receiving an accident indication from an in-vehicle computer.

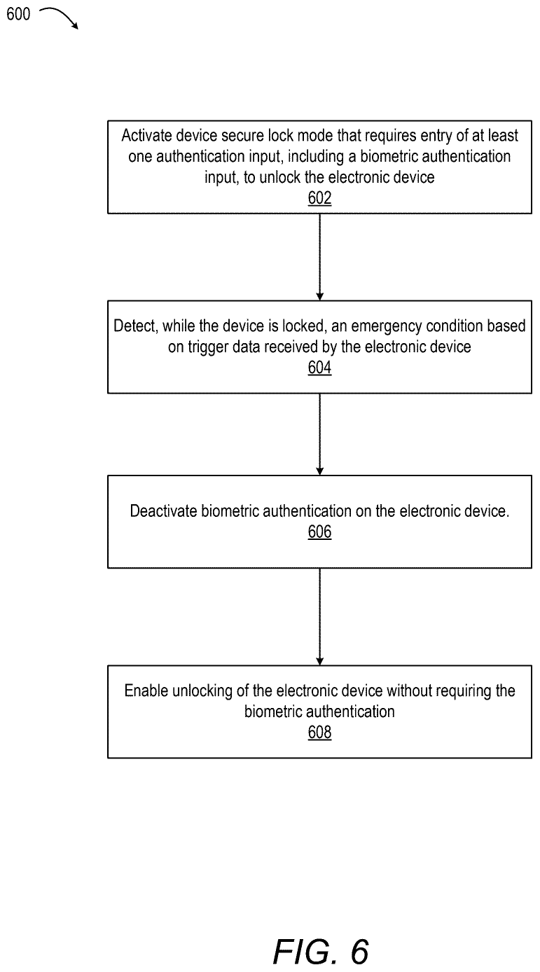

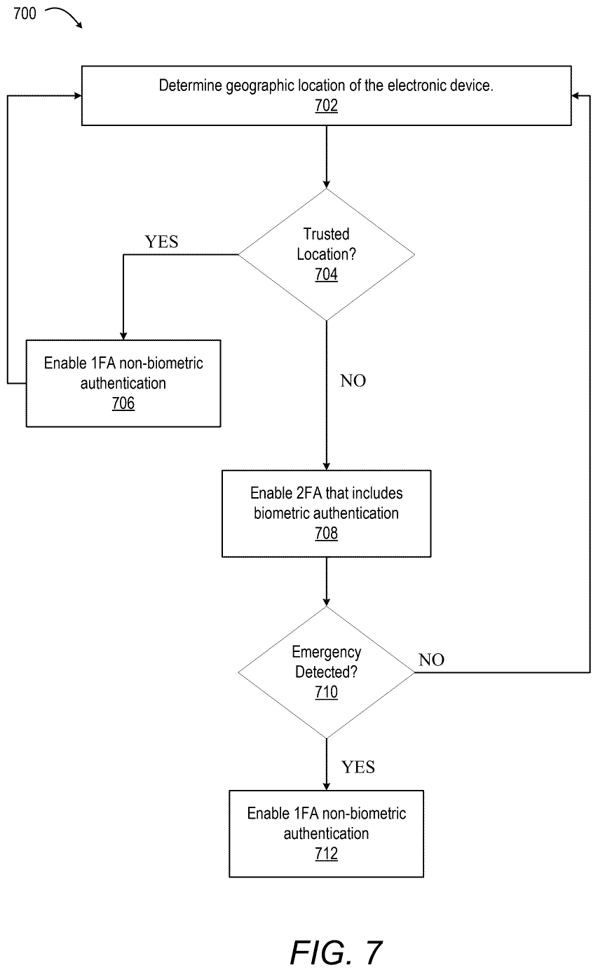

Referring now to the flowcharts presented by FIG. 6-FIG. 7, the descriptions of the methods in FIG. 6-FIG. 7 are provided with general reference to the specific components and features illustrated within the preceding FIGS. 1-5. Specific components referenced in the methods of FIG. 6-FIG. 7 may be identical or similar to components of the same name used in describing preceding FIGS. 1-5. In one or more embodiments, processor 102 (FIG. 1) configures electronic device 100 (FIG. 1) to provide the described functionality of the methods of FIG. 6-FIG. 7 by executing program code for one or more modules or applications provided within system memory 120 of electronic device 100, including emergency biometric authentication deactivation (EBAD) module 152.

FIG. 6 depicts a flowchart of a computer-implemented method for dynamically changing an authentication mode based on detection of an emergency condition, according to one or more embodiments. The method 600 starts at block 602, where activation occurs of a device secure lock mode that requires entry of at least one authentication input, including a biometric authentication input, to unlock the electronic device. The method 600 continues to block 604, where, while the device is locked, an emergency condition is detected based on trigger data received by the electronic device. The emergency condition can include a medical condition such as cardiac arrest. The emergency condition can include an environmental condition, such as detection of a vehicle accident (e.g., via an airbag sensor activation), detection of an explosion and/or gunshots (e.g., via audio data acquired from a microphone), and/or other types of emergency conditions. The method 600 continues to block 606 with deactivating biometric authentication on the electronic device. The biometric authentication can include fingerprint recognition, face recognition, iris and/or retinal scanning, voice recognition, palm and vein pattern recognition, and/or other suitable biometric authentication. The method 600 continues to block 608 with enabling unlocking of the electronic device without requiring any biometric authentication.

FIG. 7 depicts a flowchart of a computer-implemented method for selecting between a two-factor authentication (2FA) that includes biometric authentication and a non-biometric one-factor authentication (1FA) based on detection of an emergency condition, according to one or more embodiments. The method 700 starts at block 702, where a geographic location of the electronic device is determined. In one or more embodiments, the geographic location determination can be based on data received from a geolocation system such as a global positioning system (GPS) module (e.g., 160 of FIG. 1), and/or other suitable geolocation system. The method 700 continues to block 704, where a check is made to evaluate if the determined geographic location is a trusted location. In one or more embodiments, the determination can include determining that the electronic device is within a geofenced area, such as depicted in FIG. 2 at first trusted area 216 and second trusted area 218. If, at block 704, the current location of the electronic device is determined to be in a trusted location (e.g., within first trusted area 216 or second trusted area 218), the method 700 continues to block 706, where 1FA (one-factor) non-biometric authentication is enabled. The method 700 then returns to block 702 to continuously/periodically determine the geographic location of the electronic device.

If, at block 704, the current location of the electronic device is determined to be in a non-trusted location (e.g., outside of both first trusted area 216 and second trusted area 218), the method 700 continues to block 708, where 2FA (two-factor authentication) that includes at least one biometric authentication is enabled. A benefit of enabling 2FA with biometric authentication outside of trusted areas is that in the event the electronic device is stolen, even if the passcode is known, the electronic device cannot be unlocked without the biometric authentication. While normally, the aforementioned feature is a beneficial feature for preventing a data breach, in the case of an emergency condition such as an accident, it can be helpful to automatically disable the biometric authentication, so that another person, such as a relative, that may have knowledge of the pin, passcode, and/or security questions, can unlock the electronic device to access potentially important information. The important information can include medical information, such as blood type, list of medications, list of allergies, and so on. The important information can include legal information, such as a will, power-of-attorney, medical directive, living will, insurance information, and/or other legal information.

The method 700 continues to block 710, where a check is made to determine if an emergency condition is detected. If, at block 710, it is determined that an emergency condition is not detected, the method 600 then returns to block 702 to continuously/periodically determine the geographic location of the electronic device. If, at block 710, it is determined that an emergency condition is detected, the method 700 then proceeds to block 712 where 1FA non-biometric authentication is enabled. Accordingly, when 1FA non-biometric authentication is enabled, there is no biometric authentication enabled on the electronic device.

In some embodiments, the biometric authentication can be temporarily disabled on the electronic device. In one or more embodiments, even when the biometric authentication is disabled, an onboard camera may periodically obtain image data and check for face data corresponding to a face associated with biometric authentication. If the face associated with biometric authentication is detected, and the emergency condition is currently active, the user may be prompted to cancel the emergency condition, and restore normal security measures such as requiring 1FA non-biometric authentication to unlock the electronic device while in trusted locations, and 2FA that includes biometric authentication to unlock the electronic device while in non-trusted locations. In this way, the emergency condition mode can be automatically canceled once a user has been identified. As an example, as a result of an emergency condition, a user may have bandages on his face that prevent biometric authentication from being used. Once the user heals, and the bandages are removed, the user may then be recognizable by the face identification system within the electronic device. Once the user is recognized, one or more embodiments render and present a prompt to cancel the emergency condition mode. Other embodiments may restore the default security settings after a period of time, and/or after a device reboot.

One or more embodiments can include: determining a geographic location of the electronic device; determining that the geographic location is not a trusted location; and in response to determining the geographic location is not a trusted location when the emergency condition is detected: determining whether non-biometric authentication is activated on the electronic device; and in response to determining that non-biometric authentication is inactive, activating non-biometric authentication. One or more embodiments can include: activating a 2-factor authentication (2FA) mode for device screen lock on the electronic device prior to detecting the emergency condition, wherein the 2FA mode includes a biometric authentication and a non-biometric authentication; determining a geographic location of the electronic device; determining that the geographic location is not a trusted location; and in response to determining the geographic location is not a trusted location when the emergency condition is detected, dynamically changing the authentication mode from 2FA mode to a one-factor authentication mode (1FA), where the 1FA mode includes only non-biometric authentication.

As can now be appreciated, disclosed embodiments provide techniques for suspending biometric authentication for an electronic device in response to detecting an emergency condition. Thus, disclosed embodiments can provide a significant safety measure in emergencies, offering quick access to essential information when a user is unable to biometrically unlock his/her electronic device. In situations where a user is incapacitated due to illness or injury, the user's family can use the user's electronic device to retrieve any medical history, emergency contacts, medications, allergies, or doctor's information stored on the electronic device. This information can be vital for emergency responders or healthcare providers to offer appropriate treatment. Moreover, many people store copies of their identification, health insurance, driver's license, or other legal documents on their mobile electronic devices. In emergencies, a user's family member could access this information to expedite care coordination or resolve any identity verification needs. Additionally, having access to contacts, messages, or social media of a user may enable a family member to inform friends, colleagues, or employers quickly if the user is in an emergency situation. Furthermore, if the user's electronic device has stored insurance details, having access to that detail could assist in faster claims processing for health, home, and/or vehicle-related emergencies. Access to such information is crucial if family members need to make quick decisions regarding hospital admissions or other urgent financial matters. Accordingly, disclosed embodiments can serve to improve safety by intelligently disabling biometric authentication in response to detecting an emergency condition.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a display;
at least one biometric sensor enabling the electronic device to be unlocked via a biometric authentication process;
a memory having stored thereon an emergency biometric authentication deactivation (EBAD) module; and
at least one processor coupled to the display, the at least one biometric sensor, and the memory and which processes program code of the EBAD module, the at least one processor configured to cause the electronic device to:
activate a device secure lock mode comprising a screen lock that requires entry of at least one authentication input, including a biometric authentication input, to unlock the electronic device;
while the screen lock is activated, detect an emergency condition based on trigger data received by the at least one processor; and
in response to the emergency condition, deactivate biometric authentication and enable access to unlock the electronic device without requiring the biometric authentication.

2. The electronic device of claim 1, wherein:
the at least one authentication input comprises a non-biometric authentication; and
the at least one processor is further configured to, concurrently with deactivating the biometric authentication, present and render a prompt for non-biometric authentication.

3. The electronic device of claim 1, further comprising a geolocation system communicatively coupled to the at least one processor, and wherein the at least one processor is further configured to cause the electronic device to:
determine a geographic location of the electronic device;
determine that the geographic location is not a trusted location; and
in response to determining the geographic location is not a trusted location when the emergency condition is detected:
determine whether non-biometric authentication is activated on the electronic device; and
in response to determining that non-biometric authentication is inactive, activate non-biometric authentication.

4. The electronic device of claim 1, wherein to activate the device secure lock mode, the at least one processor is further configured to:
activate a 2-factor authentication (2FA) mode for device screen lock on the electronic device prior to detecting the emergency condition, wherein the 2FA mode includes a biometric authentication and a non-biometric authentication;
determine a geographic location of the electronic device;
determine that the geographic location is not a trusted location; and
in response to determining the geographic location is not a trusted location when the emergency condition is detected, dynamically change the authentication mode from 2FA mode to a one-factor authentication (1FA) mode, wherein the 1FA mode includes only non-biometric authentication.

5. The electronic device of claim 1, further comprising a communications subsystem that enables the electronic device to communicatively connect to an external device that operates as a biometric sensor, and wherein, to detect an emergency condition, the at least one processor receives, via the communications subsystem, biometric trigger data correlated to an emergency condition.

6. The electronic device of claim 1, further comprising a biometric sensor communicatively coupled to the at least one processor, and to detect an emergency condition, the at least one processor receives biometric data from the biometric sensor that is pre-established as trigger data corresponding to one emergency condition.

7. The electronic device of claim 1, further comprising a communications subsystem that enables the electronic device to communicatively connect to an in-vehicle computer, and wherein, to detect an emergency condition, the at least one processor receives an accident indication from the in-vehicle computer via the communications subsystem.

8. A method comprising:
activating, on an electronic device, a device secure lock mode comprising a screen lock that requires entry of at least one authentication input, including a biometric authentication input, to unlock the electronic device;
detecting, while the screen lock is activated, an emergency condition based on trigger data received by the electronic device; and
in response to the emergency condition, deactivating biometric authentication and enabling access to unlock the electronic device without requiring the biometric authentication.

9. The method of claim 8, wherein the at least one authentication input comprises a non-biometric authentication input, and the method further comprises, concurrently with deactivating the biometric authentication, presenting and rendering a prompt for non-biometric authentication.

10. The method of claim 8, further comprising:
determining a geographic location of the electronic device;
determining that the geographic location is not a trusted location; and
in response to determining the geographic location is not a trusted location when the emergency condition is detected:
determining whether non-biometric authentication is activated on the electronic device; and
in response to determining that non-biometric authentication is inactive, activating non-biometric authentication.

11. The method of claim 8, further comprising:
activating a 2-factor authentication (2FA) mode for device screen lock on the electronic device prior to detecting the emergency condition, wherein the 2FA mode includes a biometric authentication and a non-biometric authentication;
determining a geographic location of the electronic device;
determining that the geographic location is not a trusted location; and
in response to determining the geographic location is not a trusted location when the emergency condition is detected, dynamically changing the authentication mode from 2FA mode to a one-factor authentication mode (1FA), wherein the 1FA mode includes only non-biometric authentication.

12. The method of claim 8, wherein detecting an emergency condition comprises receiving biometric trigger data from an external device that operates as a biometric sensor, wherein the biometric trigger data is correlated to an emergency condition.

13. The method of claim 8, wherein detecting an emergency condition comprises receiving biometric trigger data from a biometric sensor within the electronic device, wherein the biometric trigger data is correlated to an emergency condition.

14. The method of claim 8, wherein detecting an emergency condition comprises receiving trigger data from an in-vehicle computer, wherein the trigger data is correlated to an emergency condition.

15. A computer program product comprising a non-transitory computer readable medium having program instructions that when executed by a processor of an electronic device, configure the electronic device to perform functions comprising:
activating a device secure lock mode comprising a screen lock that requires entry of at least one authentication input, including a biometric authentication input, to unlock the electronic device;
detecting, while the screen lock is activated, an emergency condition based on trigger data received by the electronic device; and
in response to the emergency condition, deactivating biometric authentication and enabling access to unlock the electronic device without requiring the biometric authentication.

16. The computer program product of claim 15, further comprising program instructions for:
concurrently with deactivating the biometric authentication, presenting and rendering a prompt for non-biometric authentication.

17. The computer program product of claim 15, further comprising program instructions for:
in response to detecting an emergency condition:
determining a geographic location of the electronic device;
determining that the geographic location is not a trusted location; and
in response to determining the geographic location is not a trusted location when the emergency condition is detected:
determining whether non-biometric authentication is activated on the electronic device; and
in response to determining that non-biometric authentication is inactive, activating non-biometric authentication.

18. The computer program product of claim 15, further comprising program instructions for:
activating a 2-factor authentication (2FA) mode for device screen lock on the electronic device prior to detecting the emergency condition, wherein the 2FA mode includes a biometric authentication and a non-biometric authentication;
determining a geographic location of the electronic device;
determining that the geographic location is not a trusted location; and
in response to determining the geographic location is not a trusted location when the emergency condition is detected, dynamically changing the authentication mode from 2FA mode to a one-factor authentication mode (1FA), wherein the 1FA mode includes only non-biometric authentication.

19. The computer program product of claim 15, further comprising program instructions for:
receiving biometric trigger data from a biometric sensor within the electronic device, wherein the biometric trigger data is correlated to an emergency condition.

20. The computer program product of claim 15, further comprising program instructions for:
receiving trigger data from an in-vehicle computer, wherein the trigger data is correlated to an emergency condition.
